(19) United States
(12) Patent Application Publication
(10) Pub. No.: US 2005/0278178 A1
(43) Pub. Date: Dec. 15, 2005

(54) System and method for intrusion decision-making in autonomic computing environments

(75) Inventors: Janice Marie Girouard, Austin, TX (US); Emily Jane Ratliff, Austin, TX (US); Kimberly DaShawn Simon, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/865,697

(22) Filed: Jun. 10, 2004

(51) Int. Cl. G10L 11/00

(52) U.S. Cl. 704/270

(57) ABSTRACT

A mechanism is provided for performing intrusion decision-making using a plurality of approaches. Detection approaches may include, for example, signature-based, anomaly-based, scan-based, and danger theory approaches. When event information is received, each approach produces a result. A consensus of each result is then reached by using, for example, Bayesian Filtering. A corpus is kept for each approach. An intrusion corpus keeps combinations of the corpora for all of the approaches that constitute intrusions. A safe corpus keeps combinations of the corpora for all of the approaches that do not constitute an intrusion. The corpora for the approaches may be pre-defined according to security policies and the like. The intrusion corpus and the safe corpus may be trained using scores that are determined using the detection approaches.

### BACKGROUND OF THE INVENTION

1. Technical Field

The present invention relates to data processing and, in particular, to autonomic computing environments. Still more particularly, the present invention provides a method, apparatus, and program for intrusion decision-making in autonomic computing environments.

2. Description of Related Art

Technology is moving toward autonomic computing systems that are self-configuring, self-optimizing, self-healing, and self-protecting with minimal human intervention. However, autonomic computing environments cannot be viable unless the systems are also self-securing. Adequate security must be ensured in an effective manner or autonomic computing will remain only a vision.

An autonomic computing environment may be comprised of several heterogeneously interconnected elements and, in turn, presents many challenges for ensuring sufficient security. One of these challenges involves determining effective criteria and methods for differentiating between normal system failures and those failures that are caused by malicious attacks. Due to such complex challenges, one must first solve how systems can effectively cope with intrusions.

Moreover, computing systems are destined to become infected by malicious attacks. Imagine a complex autonomic computing system that is linked to several hundreds of elements and unable to cope with a computer virus that corrupts key system functions. The virus could then proceed to corrupt vital system functions of the entire autonomic computing environment. Human intervention would result after the damage has completely penetrated the environment and, thus, resolutions would be very time consuming and costly.

Coping with intrusions is difficult in many ways. One important reason is that perspectives of both the victim and the attacker of an intrusion may be involved. Typically for an intrusion to successfully occur, the attacker has committed a malicious act that can be detected and the victim is subjected to some amount of loss. But when attacks occur that cannot be discovered, deciding what is an intrusion may become quite difficult.

### SUMMARY OF THE INVENTION

The present invention recognizes the disadvantages of the prior art and provides a mechanism for performing intrusion decision-making using a plurality of approaches. Detection approaches may include, for example, signature-based, anomaly-based, scan-based, and danger theory approaches. When event information is received, each approach produces a result. A consensus of each result is then reached by using, for example, Bayesian Filtering. A corpus is kept for each approach. An intrusion corpus keeps combinations of the corpora for all of the approaches that constitute intrusions. A safe corpus keeps combinations of the corpora for all of the approaches that do not constitute an intrusion. The corpora for the approaches may be pre-defined according to security policies and the like. The intrusion corpus and the safe corpus may be trained using scores that are determined using the detection approaches.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram illustrating an intrusion detection system in accordance with an exemplary embodiment of the present invention; and

FIG. 5 is a flowchart illustrating operation of a decision-making process for an intrusion detection system in accordance with an exemplary embodiment of the present invention.

### DETAILED DESCRIPTION OF THE PREFERRED EMBODIMENT

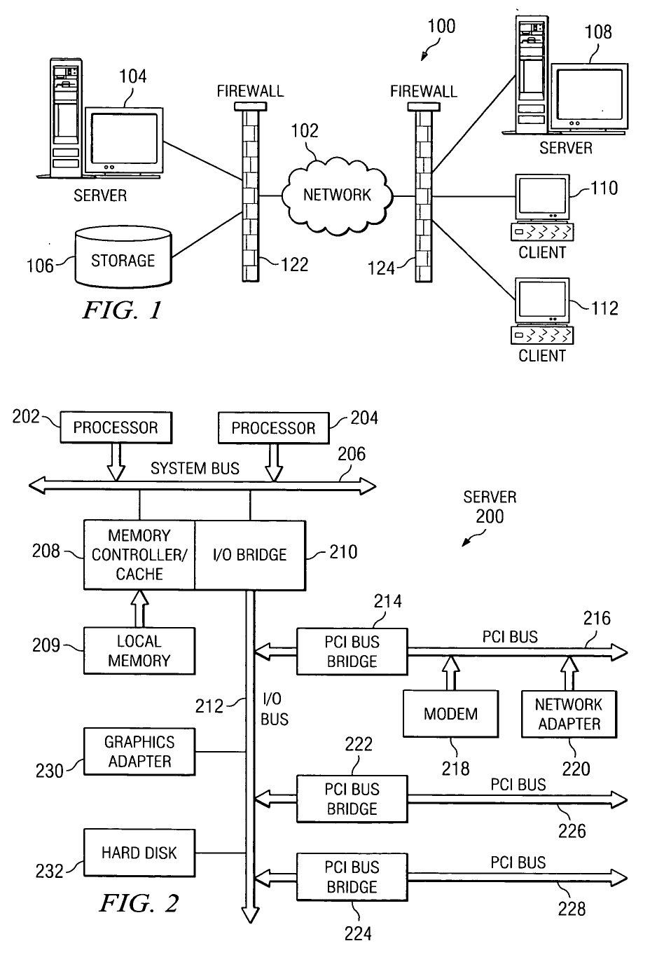

The present invention provides a method, apparatus and computer program product for performing intrusion decision-making using a plurality of approaches in an autonomic computing environment. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, server 108 and clients 110, 112 are connected to network 102. These clients 110, 112 may be, for example, personal computers or network computers. In the depicted example, servers 104, 108 may provide data, such as boot files, operating system images, and applications to clients 110, 112. Clients 110, 112 may clients to server 104 and/or server 108. Network data processing system 100 may include additional servers, clients, and other devices not shown.

All or a portion of the devices in network data processing system 100 may be protected by a firewall, such as one of firewalls 122, 124. A firewall is a mechanism for implementing security policies designed to keep a network or stand-alone system secure from intruders. A firewall may be implemented as a single router that filters out unwanted packets or may comprise a combination of routers and servers each performing some type of firewall processing.

Firewalls are widely used to give users secure access to the Internet as well as to separate a company's public Web server from its internal network. Firewalls are also used to keep internal network segments secure. For example, an accounting network might be vulnerable to snooping from within the enterprise. In practice, many firewalls have default settings that provide little or no security unless specific policies are implemented by trained personnel. Firewalls installed to protect entire networks are typically implemented in hardware; however, software firewalls are also available to protect individual workstations from attack.

Network data processing system 100 may also form an autonomic computing environment wherein all or a portion of the devices in network data processing system 100 are self-configuring, self-optimizing, self-healing, and self-protecting with minimal human intervention. However, autonomic computing environments cannot be viable unless the systems are also self-securing.

In accordance with a preferred embodiment of the present invention, an intrusion detection system is provided for performing intrusion decision-making using a plurality of approaches. Intrusion detection systems conventionally use one of several detection approaches. These approaches may include, for example, signature-based, anomaly-based, scan-based, and danger theory approaches.

A signature-based approach uses a predefined pattern to map to a known intrusion. Patterns usually lie within auditing events of a system, such as logs or records. Traditionally, these patterns are generated by a developer or system administrator to evaluate network traffic.

An anomaly-based approach uses a “baseline” in which complete knowledge of “self” or expected behavior is used to detect intrusions. Any deviations from this “baseline” of expected behavior is declared to be abnormal. The baseline may be gathered during a training or tuning phase. Traffic to and from a system or network may be gathered, analyzed, and stored.

Scan-based solutions search for suspicious scans that occur outside of a firewall to gain knowledge about various resources, such as what ports are available. Viruses, and in particular worms, seek to propagate by discovering vulnerabilities of other devices to which a device may be communicatively connected. A firewall may prevent many scan-based attacks if it is perfectly configured. However, a firewall is only as effective as the technician or administrator that configures it. Therefore, a scan-based intrusion system may identify pre-attack scanning or reconnaissance activity before a potential intrusion occurs, rather than waiting for the intrusion itself for detection.

A fairly recent intrusion detection approach being investigated is danger theory. In the danger theory approach, a system may react to foreign substances or activities based on various danger signals. Once a foreign substance enters a system, a danger response is activated. Upon a danger response, a danger zone is used to surround the foreign substance. Sensors are created in the danger zone and the sensors are notified if a danger signal indicates a strong possibility of a malicious attack.

The existing intrusion detection approaches have tradeoffs. For a signature-based approach, an attack may go unrecognized if the pattern for the attack is new, unknown, or undefined. One must know the characteristics of the intrusion for the signature-based approach to be effective. Numerous false positives can be produced because signatures for intrusions often resemble non-threatening occurrences. False positives can greatly hamper the effectiveness of a system.

For anomaly-based solutions, an accurate and complete set of normal behaviors must be determined for intrusion detection to be effective. No predefined signatures are needed. However, an anomaly-based intrusion detection approach is likely to identify abnormal but harmless and normal but harmful intrusions. There is also a good chance that intrusions can strike without being detected.

In scan-based approaches, no predefined signatures or complete knowledge of normal behaviors are needed. However, since scan-based solutions rely solely on scans, many intrusions may be undetected in the event that an attacker does not issue a scan to intrude a system. Attackers are quickly deriving new attack strategies; thus, complete reliance on one characteristic is very risky.

The danger theory approach may help alleviate the problem of “non-self but harmless” and “self but harmful” intrusions that may be missed by anomaly-based approaches. Danger theory may also address the fact that not all foreign activities will trigger a reaction. Discrimination between “self” and “non-self” may still be used in danger theory, but this discrimination is not required. The problem with the danger theory approach is that the exact nature of how to define a danger signal is unclear. Also, there may be some dangers that should not trigger a reaction.

The intrusion detection system of the present invention uses a plurality of approaches, such as, for example, the above approaches, to identify malicious activity. When event information is received, each approach produces a result. A consensus of each result is then reached by using, for example, Bayesian Filtering. A corpus is kept for each approach. An intrusion corpus keeps combinations of the corpora for all of the approaches that constitute intrusions. A safe corpus keeps combinations of the corpora for all of the approaches that do not constitute an intrusion. The corpora for the approaches may be pre-defined according to security policies and the like. The intrusion corpus and the safe corpus may be trained using scores that are determined using the detection approaches.

The intrusion detection mechanism of the present invention may be embodied on one or more devices within network data processing system 100. For example, one or both of firewalls 122, 124 may include an intrusion detection mechanism. In an autonomic computing environment, each device may be self-securing. In other words, each device in network data processing system 100 may include the intrusion detection mechanism of the present invention.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

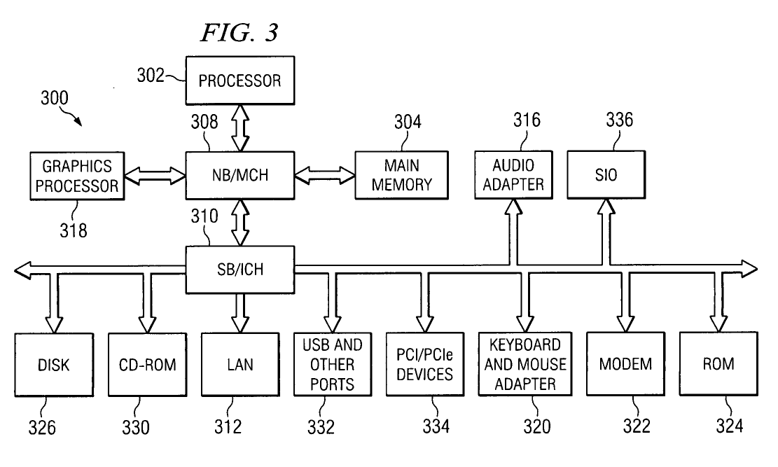

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

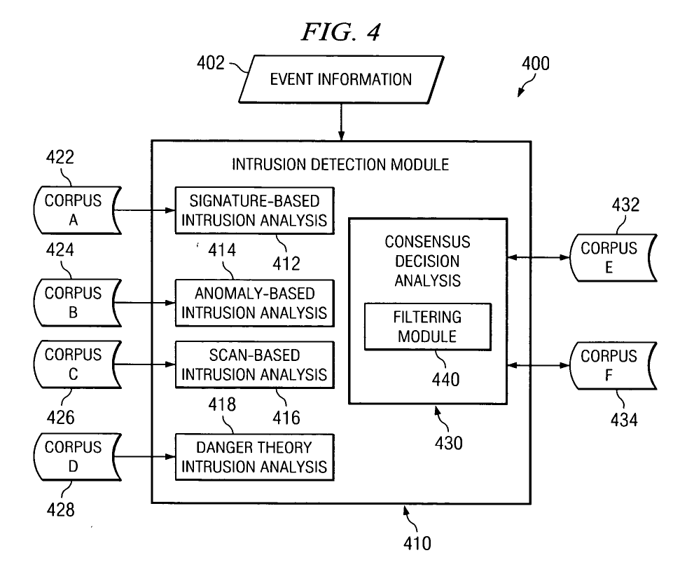

FIG. 4 is a block diagram illustrating an intrusion detection system in accordance with an exemplary embodiment of the present invention. Intrusion detection system 400 includes intrusion detection module 410, which receives event information 402 and identifies potentially malicious activity. Event information may include, for example, files being accessed, ports being accessed, percentage of resource usage, etc. Intrusion detection module 410 uses plurality intrusion detection approaches, such as signature-based intrusion analysis 412, anomaly-based intrusion analysis 414, scan-based intrusion analysis 416, and danger theory intrusion analysis 418.

Each approach produces a result based on event information 402. Consensus decision analysis 430 determines a consensus of each result from intrusion analysis modules 412-418. Consensus decision analysis 430 may use filtering module 440, which uses a filtering technique, such as multi-variant filtering.

In one implementation, filtering module 440 may use Bayesian filtering. Bayesian filtering is a process of using Bayesian probability to classify information into one of several categories. Bayesian filters rely on the fact that particular patterns have different likelihoods of occurring across different categories. To train the filter, a user may manually indicate into which category particular information belongs, and the filter will then assign a probability to each input pattern. This probability indicates the likelihood that, in the absence of any other evidence, the information belongs in a particular category. When all of the evidence is taken together and a final probability is computed, the filter will assign a category to the information if it is considered extremely likely to belong to the category. The advantage of Bayesian filtering is that it can be trained on a user-by-user basis.

In the depicted example, Bayesian filtering involves keeping multiple corpora. A corpus is a container that holds detection information, such as signatures, complete knowledge of normal behavior, behavior of suspicious scans, and danger signals, for example. The corpora are then used to identify intrusions. Corpus A 422 may store signatures for signature-based intrusion analysis 412. Corpus B 424 may store a set of normal behaviors for anomaly-based intrusion analysis 414. Corpus C 426 may store what constitutes a suspicious scan for scan-based intrusion analysis 416. And, corpus D 428 may store danger signals for danger theory intrusion analysis 418.

For the first decision about an intrusion, consensus decision analysis 430 may use filtering on corpora A-D to produce a percentage score. The score may be, for example, a ratio E:F, where E is the likelihood that the activity is an intrusion and F is the likelihood that the activity is not an intrusion. If the score is at or above a threshold, then the activity is categorized as an intrusion. The event information is then stored in corpus E 432. If the score is below the threshold, then the activity is categorized as safe. In this instance, the event information is stored in corpus F 434.

As a result, corpus E 432 stores combinations of corpora A-D that constitute intrusions and corpus F 434 stores combinations of corpora A-D that do not constitute an intrusion. Therefore, given corpora A-D, corpus E 432 and corpus F 434 may be trained over time so that intrusion detection system 400 educates itself about both known and unknown attacks. Subsequently, intrusion detection system 400 may make decisions based on corpus E 432 and corpus F 434 to take advantage of the strengths and avoid the weaknesses of the plurality of intrusion detection approaches.

Corpora A-D may be trained by a developer or system administrator. For example, an administrator may train the corpora at an administrator workstation and push updates to the corpora to other devices in an autonomic computing environment. Alternatively, corpora A-D may be stored on a server, such as server 108 in FIG. 1, for example. Each device may synchronize the corpora with the masters stored on the server. As a further example, each autonomic device may propagate updates to corpora, particularly corpora E and F, to other devices in the autonomic environment.

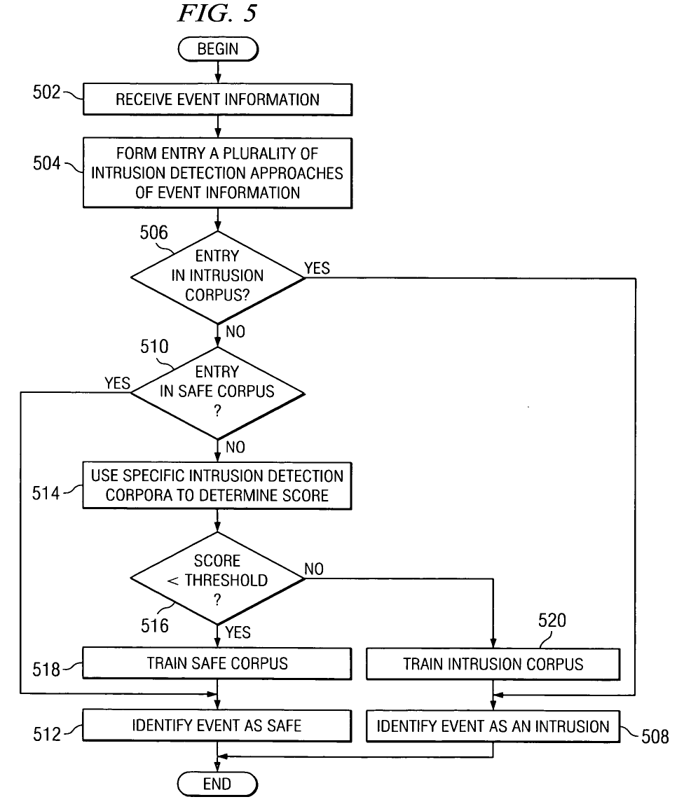

FIG. 5 is a flowchart illustrating operation of a decision-making process for an intrusion detection system in accordance with an exemplary embodiment of the present invention. Operation begins and the intrusion detection system receives event information (block 502). Next, the intrusion detection system forms an entry using a plurality of intrusion detection approaches (block 504). The entry is formed by combining information for the plurality of intrusion detection approaches.

A determination is made as to whether the entry is found in an intrusion corpus, which holds information corresponding to activity that is to be categorized as an intrusion (block 506). If the entry is found in the intrusion corpus, the intrusion detection system identifies the event as an intrusion (block 508) and operation ends. If the entry is not found in the intrusion corpus in block 506, a determination is made as to whether the entry is found a safe corpus (block 510). If the entry is found in the safe corpus, the intrusion detection system identifies the event as safe (block 512) and operation ends.

If the entry is not found in the safe corpus in block 510, the intrusion detection system uses specific intrusion detection corpora to determine a score (block 514). Next, a determination is made as to whether the score is less than a predetermined threshold (block 516). If the score is less than the threshold, the intrusion detection system trains the safe corpus (block 518). Thereafter, operation continues to block 512 where the intrusion detection system identifies the event as safe and then operation ends. If the score is not less than the threshold, the intrusion detection system trains the intrusion corpus (block 520). Thereafter, operation continues to block 508 where the intrusion detection system identifies the event as an intrusion and then operation ends.

Thus, the present invention solves the disadvantages of the prior art by providing a mechanism for performing intrusion decision-making using a plurality of approaches. The detection approaches may include, for example, signature-based, anomaly-based, scan-based, and danger theory approaches. When event information is received, each approach produces a result. A consensus of each result is then reached by using, for example, Bayesian filtering. A corpus is kept for each approach. An intrusion corpus keeps combinations of the corpora for all of the approaches that constitute intrusions. A safe corpus keeps combinations of the corpora for all of the approaches that do not constitute an intrusion. The corpora for the approaches may be pre-defined according to security policies and the like. The intrusion corpus and the safe corpus may be trained using scores that are determined using the detection approaches. Therefore, the intrusion detection mechanism of the present invention may make decisions using a plurality of approaches, thus taking advantage of the strengths and avoid the weaknesses of the plurality of intrusion detection approaches.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for detecting intrusions in a data processing system, the method comprising:
receiving behavior information;
determining a score using a plurality of intrusion detection analysis approaches; and
determining whether the behavior information constitutes an intrusion based on the score.

2. The method of claim 1, wherein determining a score using a plurality of intrusion detection analysis approaches includes comparing the behavior information to a corpus for each intrusion detection analysis approach within the plurality of intrusion detection analysis approaches.

3. The method of claim 1, further comprising:
if the behavior information constitutes an intrusion, training an intrusion corpus.

4. The method of claim 3, further comprising:
if the behavior information does not constitute an intrusion, training a safe corpus.

5. The method of claim 4, wherein the behavior information is first behavior information, the method further comprising:
receiving second behavior information;
determining whether the second behavior information matches an entry in the intrusion corpus; and
if the second behavior information matches an entry in the intrusion corpus, identifying the second behavior information as an intrusion.

6. The method of claim 4, further comprising:
determining whether the second behavior information matches an entry in the safe corpus; and
if the second behavior information matches an entry in the safe corpus, identifying the second behavior information as not constituting an intrusion.

7. The method of claim 1, wherein the plurality of intrusion detection analysis approaches includes at least one of a signature-based approach, an anomaly-based approach, a scan-based approach, and a danger theory approach.

8. The method of claim 1, wherein determining a score includes:
determining a result for each intrusion detection approach within the plurality of intrusion detection approaches based on the behavior information; and
determining a consensus of each result to form a consensus score.

9. The method of claim 8, wherein determining a consensus score includes performing filtering on the behavior information based on the result for each intrusion detection approach.

10. The method of claim 9, wherein performing filtering includes using a multi-variant filtering technique.

11. The method of claim 10, wherein the multi-variant filtering technique includes Bayesian filtering.

12. The method of claim 8, wherein the consensus score is a ratio E:F, where E is the likelihood that the behavior information constitutes an intrusion and F is the likelihood that the behavior information does not constitute an intrusion.

13. A computer program product, in a computer readable medium, for detecting intrusions in a data processing system, the computer program product comprising:
instructions for receiving behavior information;
instructions for determining a score using a plurality of intrusion detection analysis approaches; and
instructions for determining whether the behavior information constitutes an intrusion based on the score.

14. The computer program product of claim 13, wherein the instructions for determining a score using a plurality of intrusion detection analysis approaches include instructions for comparing the behavior information to a corpus for each intrusion detection analysis approach within the plurality of intrusion detection analysis approaches.

15. The computer program product of claim 13, further comprising:
instructions for training an intrusion corpus if the behavior information constitutes an intrusion.

16. The computer program product of claim 15, further comprising:
instructions for training a safe corpus if the behavior information does not constitute an intrusion.

17. The computer program product of claim 16, wherein the behavior information is first behavior information, the computer program product further comprising:
instructions for receiving second behavior information;
instructions for determining whether the second behavior information matches an entry in the intrusion corpus; and
instructions for identifying the second behavior information as an intrusion if the second behavior information matches an entry in the intrusion corpus.

18. The computer program product of claim 16, further comprising:
instructions for determining whether the second behavior information matches an entry in the safe corpus; and
instructions for identifying the second behavior information as not constituting an intrusion if the second behavior information matches an entry in the safe corpus.

19. The computer program product of claim 13, wherein the plurality of intrusion detection analysis approaches includes at least one of a signature-based approach, an anomaly-based approach, a scan-based approach, and a danger theory approach.

20. The computer program product of claim 13, wherein the instructions for determining a score include:
instructions for determining a result for each intrusion detection approach within the plurality of intrusion detection approaches based on the behavior information; and
instructions for determining a consensus of each result to form a consensus score.

21. The computer program product of claim 20, wherein the instructions for determining a consensus score include instructions for performing filtering on the behavior information based on the result for each intrusion detection approach.

22. The computer program product of claim 20, wherein the consensus score is a ratio E:F, where E is the likelihood that the behavior information constitutes an intrusion and F is the likelihood that the behavior information does not constitute an intrusion.

23. An apparatus for detecting intrusions in a data processing system, the apparatus comprising:
means for receiving behavior information;
means for determining a score using a plurality of intrusion detection analysis approaches; and
means for determining whether the behavior information constitutes an intrusion based on the score.
